(19) United States
(12) Patent Application Publication
(10) Pub. No.: US 2007/0169759 A1
(43) Pub. Date: Jul. 26, 2007

(54) Vapor fuel combustion system

(76) Inventors: Henry E. Frenette, Pittsfield, NH (US); Eugene R. Frenette, Salisbury, NH (US)

Correspondence Address: DAVIS & BUJOLD, P.L.L.C., 112 PLEASANT STREET, CONCORD, NH, 03301, US

(21) Appl. No.: 11/657,816

(22) Filed: Jan. 25, 2007

Related U.S. Application Data
(60) Provisional application No. 60/762,551, filed on Jan. 26, 2006.

(51) Int. Cl. F02M 21/02

(52) U.S. Cl. 123/525

(57) ABSTRACT

A vaporized fuel system comprising a mixing chamber, a gaseous fuel component for combining with a liquid fuel component in the mixing chamber. The gaseous fuel component mixes with the liquid fuel component to form a combustible fuel mixture which is thereafter ignited and consumed. An ample supply of additional air, e.g., oxygen, is added to the combustible fuel mixture, during combustion, to ensure substantially complete combustion and consumption of substantially of at least the liquid fuel component.

This application claims the benefit of provisional patent application Ser. No. 60/762,551 filed Jan. 26, 2006.

### FIELD OF THE INVENTION

The present invention relates to an improved fuel source which is directed at achieving “perfect combustion” of the fuel source so that substantially all of the fuel source is converted into CO₂ and H₂O without any significant amount of unburned hydrocarbons.

### BACKGROUND OF THE INVENTION

As is well known in the art, the combustion of most fuels typically results from the combustion of fuel and air whereby the byproducts are typically unburned hydrocarbons, carbon dioxide, nitric oxides, carbon monoxide, and water. One of the drawbacks associated with such combustion is that the unburned hydrocarbons are normally vented to and pollute the atmosphere. In addition, the combustion byproducts tend to leave the combustion chamber in a heated state, thus carrying heat away from the combustion region, thereby reducing the energy efficiency of the combustion system.

### SUMMARY OF THE INVENTION

Wherefore, it is an object of the present invention to overcome the drawbacks associated with the prior art combustion of fuel so as to approach a substantially “perfect combustion” in which such fuel (i.e., fuels containing hydrocarbons) and the air are substantially completely reacted with one another to result in substantially only carbon dioxide (CO₂) and water (H₂O) and unaffected nitrogen (NO₂).

A further object of the present invention is to vaporize substantially all of the fuel components and mix the vaporized fuel components with an adequate supply of air (e.g., oxygen) to thereby result in complete and thorough combustion of all of the fuel components (i.e., hydrocarbons) so as to minimize the discharge of any pollutants (e.g., unburned hydrocarbons) which are exhausted to the atmosphere. Such complete combustion thereby increases the overall energy efficiency of the combustion system.

Yet another object of the present invention is to minimize the consumption of the fuel product, during combustion, and maximize utilization of the air to thereby result in a clean and more thorough combustion of the fuel components.

A still further object of the present invention is to combine two different fuels with one another, e.g., a gaseous fuel component such as propane, natural gas, etc., and a liquid fuel component such as gasoline, kerosene, #2 home heating oil, diesel fuels such, as standard diesel fuel and bio-diesel, or some other petroleum product, with the gaseous fuel component bubbling or permeating through the liquid fuel component to form a mixed vaporized fuel component thereof which, when combined with sufficient air (e.g., oxygen), results in the complete and thorough combustion of the mixed vaporized fuel component.

The present invention also relates to a mixed vaporized fuel system comprising: a mixing chamber for facilitating mixing of a gaseous fuel component and a liquid fuel component; a gaseous fuel component storage source for storing a desired quantity of a gaseous fuel component, the gaseous fuel component storage source being coupled to the mixing chamber; a liquid fuel component storage source for storing a desired quantity of a liquid fuel, and the liquid fuel storage source being connected to the mixing chamber for supplying the liquid fuel thereto; and the mixing chamber having a supply conduit for supplying a composite combustion mixture of the vaporized gaseous fuel, the vaporized liquid fuel and air to a burner for combustion.

The present invention also relates to a mixed vaporized fuel system comprising: a liquid fuel storage source for storing a desired quantity of a liquid fuel; a pressurized gas source for supplying a pressurized gas for mixing with the liquid fuel, a mixing chamber coupled to both the liquid fuel storage source, via a liquid fuel supply conduit, and the pressurized gas source, via a pressurized gas supply conduit, and the mixing chamber facilitating mixing of the liquid fuel with the pressurized gas and formation of a combustion mixture; a spray nozzle, communicating with the mixing chamber, for spraying the combustion mixture in substantially vapor form into a combustion zone; an igniter, located in the combustion zone, for igniting the combustion mixture sprayed by the spray nozzle; and a fan for providing additional ambient air to the combustion zone mix with the combustion mixture and facilitate substantially complete combustion of the combustion mixture.

The present invention finally relates to a method of providing heat, the method comprising the steps of: supplying a liquid fuel component to a mixing chamber; supplying a pressurized gaseous fuel component to the mixing chamber; mixing the liquid fuel component and the pressurized gaseous fuel component within the mixing chamber to form a pressurized composite fuel mixture; discharging the pressurized composite fuel mixture via an aperture of a nozzle such that the pressurized composite fuel mixture is substantially atomized as the pressurized composite fuel mixture is discharged from the nozzle; supplying additional air to the pressurized composite fuel mixture; combusting the pressurized composite fuel mixture and additional air; and generating heat, for heating a building, from the combusted pressurized composite fuel mixture and the additional air.

### BRIEF DESCRIPTION OF THE DRAWINGS

The invention will now be described, by way of example, with reference to the accompanying drawings in which:

FIG. 1 is a diagrammatic drawing showing the basic components for the improved fuel combustion system according to the present invention;

FIG. 2 is a diagrammatic drawing showing a mixing chamber of the fuel combustion system in greater detail;

FIG. 3 is a diagrammatic drawing of a second embodiment of the improved fuel combustion system according to the present invention;

FIG. 4 is a diagrammatic drawing of the second embodiment of the improved fuel combustion system incorporated into a heating system; and

FIG. 5 is a diagrammatic drawing of a spray nozzle of the second embodiment of the improved fuel combustion system.

### DETAILED DESCRIPTION OF THE INVENTION

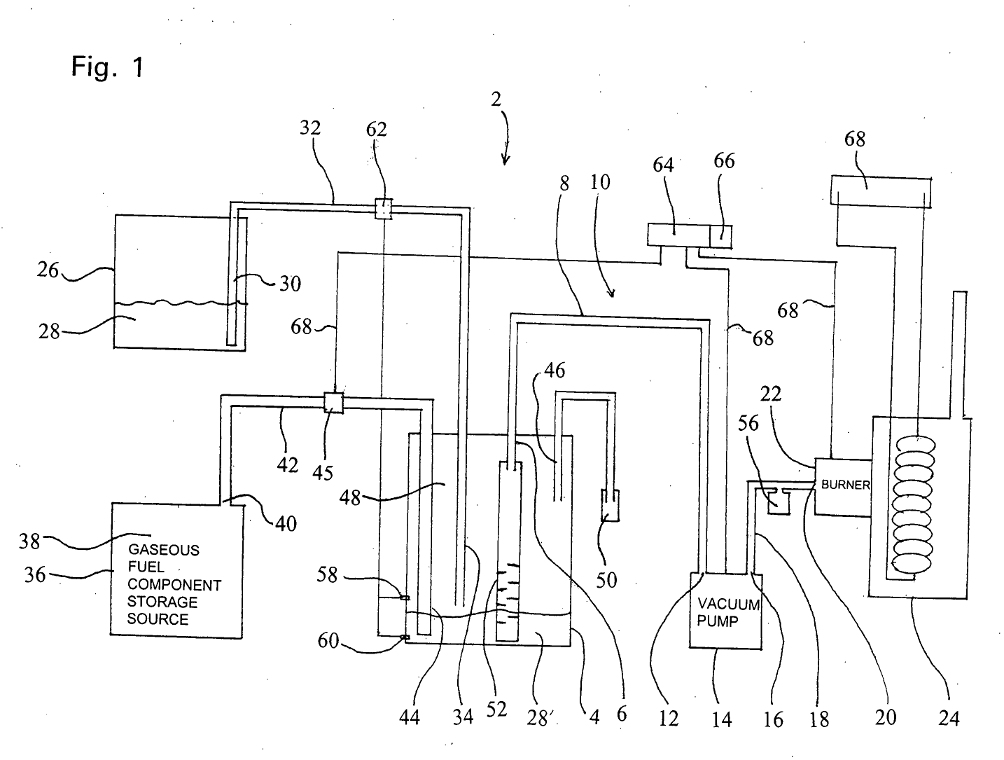

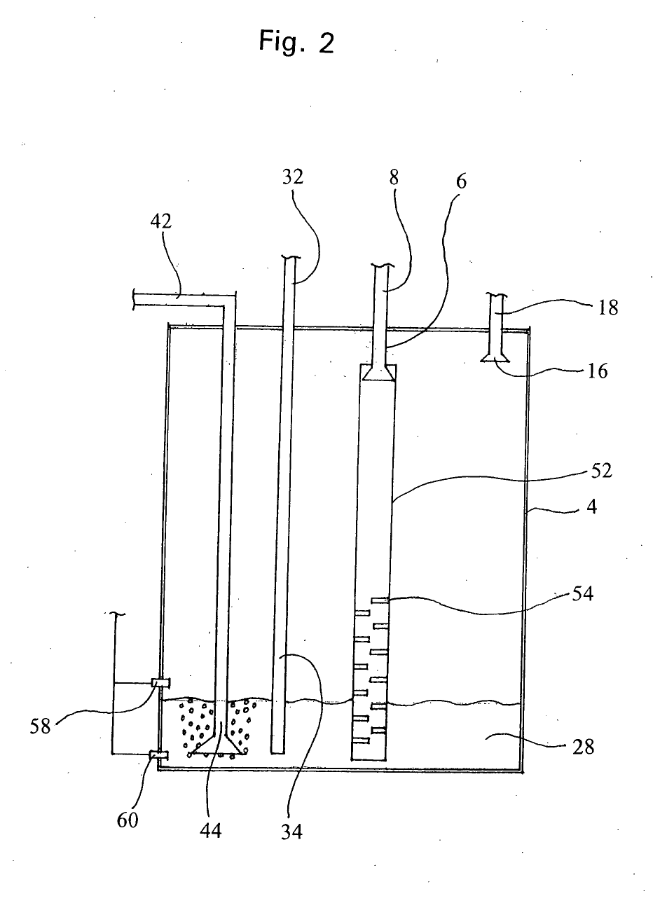

The invention will now to FIGS. 1 and 2, a detailed description concerning the vapor fuel combustion system 2, according to the present invention, will now be described in detail. As can be seen in these Figures, the vapor fuel combustion system 2 generally comprises a sealed mixing chamber 4. An outlet 6 of the mixing chamber 4 is coupled, via a first leg 8 of a vapor fuel supply conduit 10, to an inlet 12 of a vacuum pump 14. An outlet 16 of the vacuum pump 14 is coupled, via a second leg 18 of the vapor fuel supply conduit 10, to an inlet 20 of a conventional burner 22 which facilitates combustion, in a conventional manner, of the vaporized fuel supplied thereto. The burner 22 is typically located to heat a conventional furnace 24, in a normal fashion or manner, and the generated heat from the furnace 24 is disbursed thoughout a building by a conventional heating system of the building 68 (not described in further detail). As both the furnace 24 and the heating system 68 are conventional and well know and neither, per se, forms any part of the present invention, a further detailed description concerning the furnace or the heat system of the building will not be provided.

A liquid fuel component storage source 26 is provided for accommodating a desired quantity of a liquid petroleum fuel 28, e.g., 10-100 gallons, etc., of a petroleum product such as gasoline, kerosene, #2 home heating oil, diesel fuels such, as standard diesel fuel and bio-diesel, or some other petroleum product. A first end 30 of a liquid fuel supply conduit 32 communicates with and is located adjacent the bottom of the liquid fuel component storage source 26, while a second end 34 of the liquid fuel supply conduit 32 communicates with and is located adjacent the bottom or a lower region of the mixing chamber 4 to supply the desired quantity of the liquid fuel component 28 to the bottom of the mixing chamber 4 during operation of the vapor fuel combustion system 2. Typically, a quantity of the liquid fuel component 28 is allowed to accumulate in the bottom of the mixing chamber 4 and the level of liquid fuel component 28 which is allowed to accumulate may vary, depending upon the particular application and the characteristics of the mixing chamber 4. The inventors have found that a level of between about 3 inches or so is generally adequate, but other fuel levels could also be utilized and would be readily apparent, depending upon the specific application and heating requirements, to those skilled in the art.

The combustion system 2 also includes a gaseous fuel component storage source 36 which accommodates a desired quantity of the gaseous fuel component 38, e.g., propane, natural gas, etc. A first end 40 of a gaseous fuel supply conduit 42 is connected to the gaseous fuel component storage source 36 while a second end 44 of the gaseous fuel supply conduit 42 communicates with the mixing chamber 4. An outlet of the second end 44 of the gaseous fuel supply conduit 42 is located within the mixing chamber 4 so as to be submerged within the liquid fuel component 28 accommodated therein, e.g., be submerged by at least 1 inch or so. The gaseous fuel conduit 42 has a regulator valve 45 for completely interrupting and/or regulating the flow of gaseous fuel component 38 supplied from the gaseous fuel component storage source 36 to the liquid fuel component 28 contained within the mixing chamber 4. Typically the flow pressure of the gaseous fuel component 38 is about ⅛ pound of pressure or so. Such pressure is typically adequate to allow a sufficient flow of the gaseous fuel component 38 to the mixing chamber 4 for bubbling and permeating through the liquid fuel component 28 located within the mixing chamber 4 and thereby inducing some of the liquid fuel component 28 to become vaporized and mixed with the gaseous fuel component 38 and result in the formation of a substantially uniform mixture thereof. It will be appreciated, by those skilled in the art, that other supply pressures may be utilized depending upon the specific application and the heating requirements. Preferably the outlet of the second end 44 of the gaseous fuel supply conduit 42 has an enlarged outlet (not shown in detail) to facilitate supply of the gaseous fuel component throughout the liquid fuel component 28 accommodated within the mixing chamber 4.

In addition, the mixing chamber 4 is provided with one or more air intake inlet(s) 46 for allowing an adequate quantity of room air (e.g., oxygen) to flow or enter the mixing chamber 4 and mix with the vaporized liquid and the gaseous fuel components and thereby form a substantially uniform vaporized mixture thereof, e.g., form a vaporized fuel mixture 48. The air intake inlet 46 normally has a check valve 50 associated therewith to ensure that the room air is only allowed to enter the mixing chamber 4 when the vapor fuel combustion system 2 is operating, e.g., the vacuum pump 14 is operating and drawing from the mixing chamber 4 and supplying the vaporized fuel mixture to the burner 22 but not allow any of the vaporized fuel components to flow out through the air intake check valve(s) 46.

To assist with creation of a substantially uniform vaporized fuel mixture 48 of the vaporized liquid fuel component 28, the gaseous fuel component 38, and the air, a sparger/diffuser member 52 is located so as to separate the intake 6 of the first leg 8 of the vapor fuel supply conduit 10 from a remainder of the interior space of the mixing chamber 4. That is, the vaporized liquid and gaseous fuel components 28, 38 as well as the air must generally pass through one or more small opening or passages 54, formed in the sparger/diffuser member 52, prior to those components being sucked into the intake 6 of the first leg 8 of the vapor fuel supply conduit 10 and conveyed to the burner 22 for combustion.

The vacuum pump 14 is typically a piston pump which is capable of achieving about 30 pounds of suction at the intake 6 of the first leg 8 of the vapor fuel supply conduit 10 during operation. Preferably the first leg 8 of the vapor fuel supply conduit 10 has a larger diameter than the second leg 18 of the vapor fuel supply conduit 10 which supplies the vaporized fuel from the vacuum pump 14 to the burner 22. According to one embodiment, the first leg 8 of the vapor fuel supply conduit 10 has a diameter of about ⅜ of an inch or so while the second leg 18 of the vapor fuel supply conduit 10 has a diameter of about ¼ of an inch or so. It is to be appreciated that other sizes would be readily apparent to those skilled in the art without departing form the spirit and scope of the present invention.

Typically a water trap 56 is provided along either the first leg 8 and/or the second leg 18 of the vapor fuel supply conduits 10, or both legs, to facilitate removal of any liquid fuel 28 which may possibly condense while flowing along the vapor fuel supply conduit 10 from the mixing chamber 4 to the burner 22.

Preferably the intake 6 of the first leg 8 of the vapor fuel supply conduit 10 is located approximately 18 inches or so above the level of the liquid fuel component 28 contained within the mixing chamber 4. In addition, preferably a pair of air inlets 46 are provided in the mixing chamber 4 (e.g., one adjacent each side of the mixing chamber 4) to ensure that an adequate supply of air is allowed to enter into the mixing chamber 4 to mix with the gaseous and liquid vaporized fuel components 28, 38 and facilitate formation of vaporized fuel mixture which promotes substantially perfect combustion of the vaporized fuel mixture upon combustion.

Preferably the lower section of the mixing chamber 4 is provided with a high level and low level liquid fuel component sensors 58, 60 which are each connected to a flow valve 62 located along the liquid fuel supply conduit 32, to facilitate maintaining a desired level of the liquid fuel component 28 within the mixing chamber 4 during operation. When the low level sensor 60, for the liquid fuel component 28, determines that the level of the liquid fuel component 28 is below the low level sensor 60, a signal is sent to the flow valve 62 to open the valve 62 and allow the liquid fuel component 28 to flow from the liquid fuel component storage source 26 into the mixing chamber 4 and raise the level of the liquid fuel component 28 into the mixing chamber 4 until the high level sensor 58 detects the liquid fuel component 28. Thereafter, the high level sensor 58 sends a signal to the flow valve 62 to close the valve 62 and interrupt or discontinue the flow of additional liquid fuel component 28 into the mixing chamber 4. It is to be appreciated that other fluid level indicators and flow valve controllers would be readily apparent to those skilled in the art without departing form the spirit and scope of the present invention.

A heating system control unit 64 communicates with each of the gaseous fuel regulating valve 45, the vacuum pump 14, the burner 22 and a thermostat 66 via conventional electrical lines and/or connections 68. The thermostat 66 sends signals to the control unit 64 to either commence or terminate operation of the combustion system 2, depending on the current temperature detected by the thermostat 66 associated with the control unit 64. When the thermostat 66 indicates a low temperature within the building, the control unit 64 activates the combustion system 2 and also activates burner 22. The vacuum pump 14 will initiate operation and supply the burner 22 with the necessary quantity of vaporized fuel mixture 48. The control unit 64 will also open the gaseous fuel regulating valve 45 to commence the supply of the gaseous fuel 38 to the mixing chamber 4.

Operation of the vapor fuel combustion system 2 will now be described. When the heating system 68 requires additional heat, as determined by the thermostat 66 or some other conventional devices, the control unit 64 opens the flow valve 45 for the gaseous fuel component 38 to allow the gaseous fuel component 38 to flow from the gaseous fuel component storage source 36 through the regulator valve 45 and into the mixing chamber 4. The gaseous fuel component 38 then permeates and bubbles through the liquid fuel component 28, contained in the bottom of the mixing chamber 4, to induce vaporization thereof. At the same time, the vacuum pump 14 commences operation to syphon and/or withdraw the vaporized fuel components, once adequately mixed with room air, from the mixing chamber 4 and supply the vaporized fuel mixture to the burner 22 for combustion via the vapor fuel supply conduit 10 and the vacuum pump 14. The evacuation of the vaporized fuel mixture 48 from the mixing chamber 4 causes a negative pressure within the mixing chamber 4. This negative pressure opens the check valve 50, associated with the air intake inlet 46, to allow additional atmospheric air to enter the mixing chamber 4.

After receiving a signal from the control unit 64, the burner 22 ignites the supply of vaporized fuel mixture, in a conventional fashion, and the combustion gases generate heat which is used to heat a conventional hot water heating system 68, for example, or a conventional forced hot air heating system, etc.

During operation, once a sufficient quantity of the liquid fuel 28 component becomes vaporized such that the low level sensor 60 detects an insufficient quantity of the liquid fuel component 28, additional liquid fuel component 28 is allowed to flow from the liquid fuel component storage source 26 into the mixing chamber 4.

Once the burner 22 generates sufficient heat to the furnace 24 and the associated heating system 68 and this heat is disbursed throughout the building, the thermostat 66 eventually detects an adequate increase in temperature within the building and indicates the same to the control unit 64. The control unit 64 then automatically shuts down the vapor fuel combustion system 2, e.g., turns or shuts off the burner 22 and the vacuum pump 14 and closes the regulator valve 45 supplying the gaseous fuel component 38 to the mixing chamber 4. This, in turn, allows the check valve 50 for the air intake(s) 46 to close automatically and seal and thereby prevent additional air from entering into the mixing chamber 4 and/or allow any of the vaporized fuel components, contained within the mixing chamber 4, to escape therefrom into the room or atmosphere.

Preferably the mixing chamber 4 is a completely sealed unit which has a storage capacity of between 5 and 300 cubic feet or so and more preferably has a storage capacity of between about 10 and 50 cubic feet.

The inventors of the present invention believe that by permeating the gaseous fuel component 38 through the liquid fuel component 28, such as by bubbling and permeation, induces vaporization of the liquid fuel component 28 and thereby results in the formation of a composite vaporized fuel mixture 48 which minimizes the amount of any unburned hydrocarbons in the combustion byproducts and thus facilitates extracting virtually all of the BTU energy from the composite vaporized fuel mixture during conventional combustion thereof. That is, the present invention is believed to approach substantially “perfect combustion” of the composite vaporized fuel mixture such that all of the fuel (e.g., hydrocarbons) is combined with a sufficient supply of air (e.g., oxygen and nitrogen) and, upon combustion thereof, generally only results in carbon dioxide and water, plus unaffected nitrogen, as the sole combustion byproducts.

It is to be appreciated that the present invention may be also useful in a commercial production facility for manufacture of a composite vaporized fuel mixture. That is, the commercial production facility will include a commercial gaseous fuel component source, a commercial liquid fuel component source, a commercial mixing chamber and one or more commercial vacuum pump(s). The vacuum pump(s) would supply the vaporized fuel mixture to an associated compressor for compressing the vaporized fuel mixture, at high pressure, and storing the same in suitable conventional pressurized containers, e.g., 20 lbs., 50 lbs., 100 lbs., 200 lbs., etc., pressurized containers. Each such pressurized container would thus already have the desire amount of vaporized fuel, from both fuel sources, as well as a desired amount of oxygen to facilitate direct supply of this fuel source to a burner without requiring the addition of any additional oxygen thereto prior to combustion.

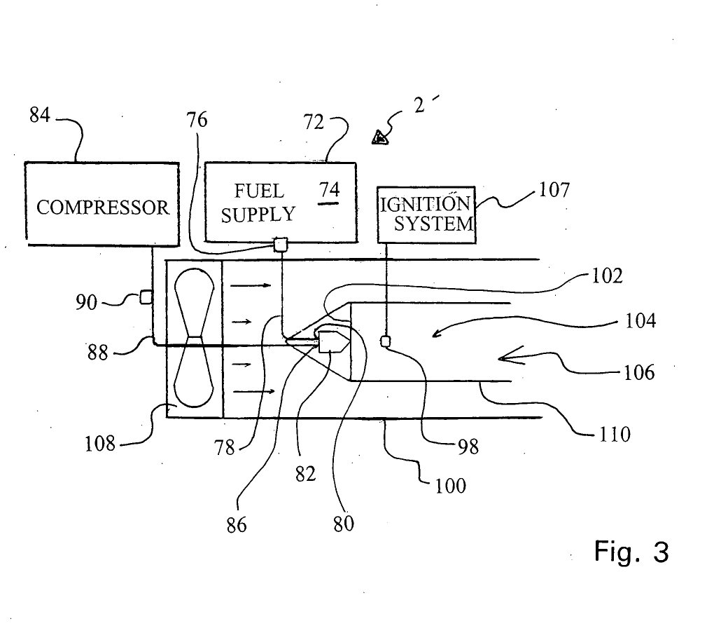

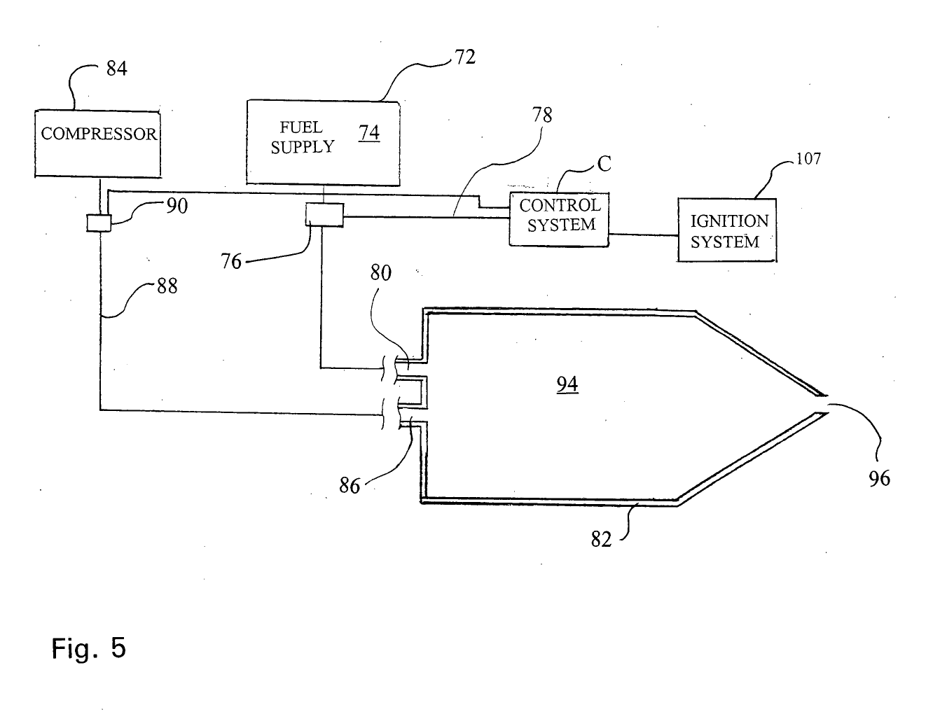

Turning now to FIGS. 3 and 5, a detailed description concerning a second embodiment of the vapor fuel combustion system 2′, according to the present invention, will now be described in detail. As can be seen in these Figures, the second embodiment of the vapor fuel combustion system 2′ generally comprises a liquid fuel supply storage tank 72, e.g., approximately 10-300 gallons or so, of a petroleum product accommodating a desired quantity of a liquid fuel component 74 such as gasoline, #2 home heating oil, kerosene, standard diesel fuel, or bio-diesel fuel, for example. An adjustable flow valve 76, typically located adjacent the bottom of the fuel supply storage tank 72 or in a liquid fuel supply conduit 78 coupled thereto, regulates the flow rate of the liquid fuel which is allowed to flow from the fuel supply storage tank 72 to the combustion system 2′. The flow valve 76 can be either a manually adjustable or controllable flow valve or, more preferably, an automatically adjustable or controllable flow valve which is coupled to a control system C (see FIG. 5) for controlling the flow of liquid fuel from the liquid fuel supply storage tank 72. As the adjustable or controllable flow valve 76 is conventional and well known, a further detailed description concerning such valve will not be provided. The liquid fuel supply conduit 78 is coupled to either the adjustable or controllable flow valve 76 or the liquid fuel supply storage tank 72 for supplying the fuel from the fuel supply storage tank 72 to an liquid fuel (first) inlet 80 of a pressured spray nozzle 82.

A compressor or a pressurized gas source 84, e.g., air, oxygen, etc., is coupled to a pressurized gas (second) inlet 86 of the pressure spray nozzle 82 via a pressurized gas supply conduit 88. A gas pressure valve 90 is provided either at the compressor or the pressurized gas source 84 or along the pressurized gas supply conduit 88 for adjusting the pressure and the flow rate of the gas as the gas flows along the conduit 88. The gas pressure valve 90 typically adjusts the gas pressure such that the mixing chamber is maintained at a pressure of, for example, between about 3 and 8 psi. The pressurized gas is introduced into the spray nozzle 82, via the pressurized gas (second) inlet 86 located adjacent a rear of the spray nozzle 82, while the liquid fuel is introduced into the spray nozzle 82, via the liquid fuel (first) inlet 80 also located adjacent the rear of the spray nozzle 82. It is to be appreciated that the location of the first and the second inlets 80, 86 could vary. The fuel supplied via the pressurized gas (second) inlet 86 and the liquid fuel inlet 80 both communicate with one another in an internal mixing chamber 94 within the spray nozzle 82. The liquid fuel and the pressurized gas mix with one another, at an elevated pressure, within the mixing chamber 94 to form a composite fuel mixture, and this fuel mixture is then accelerated as the fuel mixture is discharged out via the relatively small discharge opening 96 of the spray nozzle 82, e.g., an opening of between about 0.01 and 0.05 inches or so. Due to the relatively high pressure of the mixing chamber 94 and the relatively small size of the discharge opening 96 of the spray nozzle 82, the mixture is essentially atomized substantially immediately upon being discharged from the spray nozzle 82. That is, the discharge opening 96 of the spray nozzle 82 and the pressure difference between the pressure of the internal mixing chamber 94 and the atmospheric pressure located downstream of the spray nozzle 82 are such that sufficiently all of the liquid fuel becomes instantaneously atomized so as to be immediate suitable for combustion.

A conventional igniter 98 is located downstream but sufficiently close to the discharge opening 96 of the spray nozzle 82 to facilitate ignition of the fuel mixture being discharged and atomized by the spray nozzle 82. To facilitate substantially complete combustion of the fuel mixture, the ambient air is forced into a first end 102 of a burner housing 100, and this ambient air is initially heated as this air passes through a burn zone—the burn zone 104 is an area within the flame shroud 110 where the atomized liquid fuel is ignited by the igniter 98 of the ignition system. The ignition system includes the ignitor 98 arranged along the axis of the vapor fuel combustion system 2′, downstream from the spray nozzle 82, so that as the atomized liquid fuel mixture is sprayed into the flowing stream of ambient air, the ignitor 98 is energized and thus ignites the atomized liquid fuel mixture. The ignitor 98 may include a pilot flame, an electrical spark, a glowing resistor, etc., and communicates with an ignition control system 107 which energizes or interrupts the flow of electrical power, for example, to the ignitor 98. As the igniter 98 and a remainder of the ignition control system 107 is conventional and well known, a further detailed description concerning the same is not provided

The flame shroud 110 is accommodated within the burner housing 100 and is generally in the form of a cylindrical tube which has a diameter of between 2 and 12 inches. The flame shroud 110 surrounds and encases the spray nozzle 82. The spray nozzle 82 is arranged within the elongate burner housing 100 so as to discharge the fuel along a central axis of the vapor fuel combustion system 2′. It is to be appreciated that the overall size, shape and configuration of the burner housing 100 and the flame shroud 110 may vary, depending upon the particular application, but is generally designed so as to induce sufficient air flow from the open first end 102, of the flame shroud 110, to an opposed second open end 106 thereof. The first end 102 of the housing is generally open so as to allow an inward flow of ambient air, into the flame shroud 110, and thereby ensure substantially complete combustion of all of the supplied fuel. To assist with air flowing through the flame shroud 110, a fan or blower 108, for example, may be provided to drawing or forcing ambient air into the first open end 102 of the flame shroud 110 and channeling or directing such air therethrough toward the second open end 106 thereof. Preferably a speed of the fan or the blower 108 is adjustable in order to regulate the velocity of the ambient air being forced or directed through the burner housing 100, e.g., at a flow rate of between 5 feet per second to about 100 feet per second or so, for example. The flame shroud 110 restricts the combustion of the fuel mixture along the axis of the vapor fuel combustion system 2′ so as prevent the burner housing 100 from becoming excessively hot during the combustion process.

The vapor fuel combustion system 2′, of the second embodiment, allows adjustment of the fuel flow rate to the spray nozzle 82, adjustment of the pressurized gas flow rate to the spray nozzle 82 and the amount and the velocity of the ambient air allowed to mix with the sprayed fuel mixture, within the burner housing 100, to ensure a substantially complete combustion of all of the sprayed fuel mixture. As the flow rate of the liquid fuel decreases, the amount of ambient air forced through the combustion system 2′ is generally correspondingly decreased. As the flow rate of the liquid fuel increases, the amount of ambient air forced through the combustion system 2′ will also generally correspondingly increase. As the flow of pressurized gas increases or decreases, the difference in pressure between the mixing chamber 94 and the atmosphere outside of the spray nozzle 82 changes thus altering the burning efficiency of the liquid fuel.

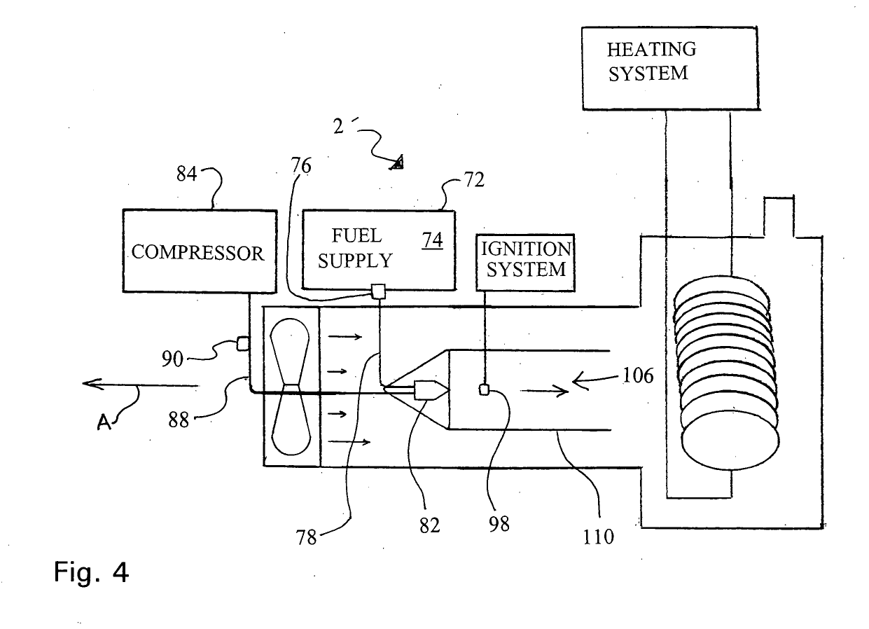

The vapor fuel combustion system 2′, according to the present invention, may be incorporated into an individual space heater or used as a burner or a heat source for a conventional furnace of a heating system, as diagrammatically shown in FIG. 4. The heating system used with the vapor fuel combustion system would be similar to any known heating system having a heating chamber with a water heating coil, a water inlet and a water outlet.

Since certain changes may be made in the above described improved vapor fuel combustion system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A mixed vaporized fuel system comprising:
a liquid fuel storage source for supplying a desired quantity of a liquid fuel;
a pressurized gas source for supplying a pressurized gas for mixing with the liquid fuel,
a mixing chamber coupled to both the liquid fuel storage source, via a liquid fuel supply conduit, and the pressurized gas source, via a pressurized gas supply conduit, and the mixing chamber facilitating mixing of the liquid fuel with the pressurized gas and formation of a combustion fuel mixture;
a spray nozzle, communicating with the mixing chamber, for spraying the combustion fuel mixture in substantially vapor form into a combustion zone;
an igniter, located in the combustion zone, for igniting the combustion fuel mixture sprayed by the spray nozzle; and
a fan for providing additional ambient air to the combustion zone mix with the combustion fuel mixture and facilitate substantially complete combustion of the combustion fuel mixture.

2. The system according to claim 1, wherein the liquid fuel supply conduit has a flow valve for regulating a flow rate of the liquid fuel component from the liquid fuel storage source to the mixing chamber.

3. The system according to claim 1, wherein the pressurized gas supply conduit has a flow valve for regulating a flow rate of the pressurized gas from the pressurized gas source to the mixing chamber.

4. The system according to claim 1, wherein an opening of the spray nozzle is between 0.01 and 0.05 inches.

5. The system according to claim 1, wherein during operation of the system, the mixing chamber operates at a pressure of between 3 and 8 psi.

6. The system according to claim 1, further comprising a flame shroud essentially extending along and encasing the combustion zone to space the ignited combustion fuel mixture from a housing of the system.

7. The system according to claim 6, wherein the liquid fuel supply flow valve communicates with a control system which automatically adjusts the flow of the liquid fuel from the liquid fuel supply storage through the liquid fuel supply conduit to the mixing chamber.

8. The system according to claim 1, wherein the liquid fuel supply conduit has a flow valve for regulating a flow rate of the liquid fuel component from the liquid fuel storage source to the mixing chamber, and liquid fuel supply flow valve communicates with a control system which automatically adjusts the flow of the liquid fuel from the liquid fuel supply storage through the liquid fuel supply conduit to the mixing chamber; and
the pressurized gas supply conduit has a flow valve for regulating a flow rate of the pressurized gas from the pressurized gas source to the mixing chamber, and the pressurized gas flow valve communicates with the control system which automatically adjusts the flow of the pressurized gas from the pressurized gas source through the pressurized gas supply conduit to the mixing chamber.

9. The system according to claim 1, wherein the fan provides the additional ambient air to the combustion zone at a flow rate of between 5 feet per second to about 100 feet per second.

10. The system according to claim 1, wherein the mixing chamber is maintained at a pressure of between 3 and 8 psi and an opening of the spray nozzle is between about 0.01 and 0.05 inches so that the liquid fuel component of the combustion fuel mixture is essentially atomized immediately upon the combustion fuel mixture being sprayed into the combustion zone.

11. The system according to claim 1, wherein the liquid fuel supply conduit has a flow valve for regulating a flow rate of the liquid fuel component from the liquid fuel storage source to the mixing chamber;
the pressurized gas supply conduit has a flow valve for regulating a flow rate of the pressurized gas from the pressurized gas source to the mixing chamber;
during operation of the system, the mixing chamber operates at a pressure of between 3 and 8 psi; and
the fan provides the additional ambient air to the combustion zone at a flow rate of between 5 feet per second to about 100 feet per second.

12. A mixed vaporized fuel system comprising:
a mixing chamber for facilitating mixing of a gaseous fuel component and a liquid fuel component to form a vaporized fuel component;
a gaseous fuel component storage source for storing a desired quantity of the gaseous fuel component, and the gaseous fuel component storage source being coupled to the mixing chamber;
a liquid fuel component storage source for storing a desired quantity of the liquid fuel component, and the liquid fuel storage source being connected to the mixing chamber for supplying the liquid fuel component thereto; and
a supply conduit for supplying a composite fuel mixture of the vaporized fuel component and air from the mixing chamber to a burner for combustion.

13. The system according to claim 12, further comprising a vacuum pump coupled to the supply conduit for withdrawing the vaporized fuel component and the air from the mixing chamber, once adequately mixed, and supplying the composite fuel mixture as fuel for the burner.

14. The system according to claim 12, wherein a gaseous fuel supply line includes a regulator for regulating a flow rate of the gaseous fuel component from the gaseous fuel component storage source to the mixing chamber.

15. The system according to claim 12, wherein an electronic valve is located in a gaseous supply conduit for interrupting the flow of the gaseous fuel component from the gaseous fuel component storage source to the mixing chamber.

16. The system according to claim 15, wherein an electronic valve is located in a liquid fuel supply conduit for interrupting the flow of the liquid fuel component from the liquid fuel component storage source to the mixing chamber.

17. The system according to claim 16, wherein the mixing chamber has a high level sensor and a low level sensor and the high and low level sensors communicate with the electronic valve located in the liquid fuel supply conduit for maintaining a level of the liquid fuel component within the mixing chamber between the high and the low level sensors.

18. The system according to claim 13, wherein a member is located within the mixing chamber to facilitate adequate mixing of the vaporized fuel component with the air prior to the composite fuel mixture being withdrawn by the vacuum pump and supplied to the burner.

19. The system according to claim 16, wherein a control unit communicates with the electronic valve located in the gaseous supply conduit, the electronic valve located in the liquid fuel supply conduit and a vacuum pump coupled to the supply conduit for respectively controlling a flow of the gaseous fuel component from the gaseous fuel component storage source to the mixing chamber, a flow of the liquid fuel component from the liquid fuel component storage source to the mixing chamber and a flow of the vaporized fuel component, mixed with the air, from the mixing chamber to a burner.

20. A method of providing heat, the method comprising the steps of:
supplying a liquid fuel component to a mixing chamber;
supplying a pressurized gaseous fuel component to the mixing chamber;
mixing the liquid fuel component and the pressurized gaseous fuel component within the mixing chamber to form a pressurized composite fuel mixture;
discharging the pressurized composite fuel mixture, via an aperture of a nozzle, such that the pressurized composite fuel mixture is substantially atomized as the pressurized composite fuel mixture is discharged from the nozzle;
supplying additional air to mix with the pressurized composite fuel mixture and facilitate combustion;
combusting the pressurized composite fuel mixture and the additional air; and
generating heat, for heating a building, from the combusted pressurized composite fuel mixture and the additional air.
